(19) United States
(12) Patent Application Publication
(10) Pub. No.: US 2004/0182673 A1
(43) Pub. Date: Sep. 23, 2004

(54) Transfer chute and method of operating the chute

(76) Inventor: Werner Josef Baller, Gauteng (ZA)

Correspondence Address: BIRCH STEWART KOLASCH & BIRCH, PO BOX 747, FALLS CHURCH, VA, 22040-0747, US

(21) Appl. No.: 10/765,064

(22) Filed: Jan. 28, 2004

Related U.S. Application Data
(60) Provisional application No. 60/443,182, filed on Jan. 29, 2003.

(51) Int. Cl. B65G 11/00

(52) U.S. Cl. 193/32; 193/27

(57) ABSTRACT

This invention relates to transfer points for flowable particulate bulk materials, particularly transfer chutes and more particularly to a method of operating and constructing such chutes. In one form, this invention provides a method of using the design capabilities afforded by transfer chutes like the chute described and claimed in SA Patent 91/7215—Chute (Baller). These chutes use cascade formations to accumulate quantities of the bulk materials being conveyed thereby to create an accurately definable chute liner. This invention provides a method of utilising this design capability to create a self-lining materials transfer chute 200. The method comprises the steps of using a plurality of cascade formations (such as trays 224) with free edges that project into the chute and face the intended incoming materials flow 216. The trays 224 define ledges that serve, co-operatively, as dead boxes into which the bulk material is projected upon material flow through the chute. The trays are dimensioned such that the dead boxes accumulate just sufficient of the conveyed material to form a lining of accumulated material through which only parts of the free edges of the trays 224 are exposed to the bulk material flowing through the chute. The trays 224 are dimensioned such that the trays 224 and the material accumulated therein are adapted, in use, to form a composite dead box, the surface of which is exposed, as a wear surface 228, to the incoming material. The wear surface 228 is accurately determinable since it is co-extensive with imaginary lines of curvature connecting the free edges of the trays 224. This makes it possible, once the designer has determined the flow characteristics desired of the flowing stream of material 216, to dimension the trays 224 in dependence on these desired flow characteristics.

### BACKGROUND TO THE INVENTION

This invention relates to transfer points for flowable particulate bulk materials, particularly transfer chutes and more particularly to a method of operating and constructing such chutes.

Belt conveying is accepted as one of the most effective and reliable modes of transporting flowable bulk materials. The feeding and transfer of bulk materials onto and from belt conveyors is normally controlled by gravity flow hopper/feeder combinations and in the majority of cases the materials are finally directed onto the belt through a gravity flow transfer point in which a chute serves as the final flow directing device.

The term “flowable” when used in this specification in relation to bulk particulate materials, refers to a solid material that has been broken up into particles (without necessarily having regard to particle size) and that will “flow”, fall, tumble or cascade gravitationally down an inclined passage or down a slope that is steeper than the angle of repose of the material.

The method and apparatus of the invention are concerned with material that is conveyed in bulk, that is in a relatively freely flowing stream of material that is not contained other than by the lined surfaces of the passage and that is not contained or conveyed in any form of container.

It is generally accepted that one of the most important factors in the successful operation of belt conveyors and possibly the major factor affecting belt life, is the method of loading bulk materials onto the belt. This obviously covers all conveyor loading situations, but it applies particularly to bulk materials transfer points in multiple conveyor systems, with chutes being the most important such transfer points.

In view of their obvious simplicity, the design of transfer and feed chutes has been neglected in the past and, as a result, these transfer points are often the weakest link in the materials conveying “chain”. In this regard, a lack of attention to design detail leads to major problems, such as flow blockages, spillage and accelerated belt and transport equipment wear.

Another drawback associated with existing material transfer points, and it is one that is of increasingly greater importance, is the environmental hazard they constitute. Transfer chutes, by and large, are known for their contribution to environmental degradation rather than their compliance with high environmental standards. This is due to the high dust and noise pollution levels normally associated with transfer chutes.

It is now generally accepted that a chute assembly should comply with certain essential requirements. For instance, the chute assembly must load the material symmetrically onto the receiving belt in order to prevent belt mistracking and spillage. In addition, the chute must accommodate the variable physical characteristics of the bulk materials. Also, the chute must accommodate the acceptable size variation of the product being conveyed over the range of flow rates required and the chute must not choke or bridge with the material or with tramp.

Transfer chutes are areas of extraordinarily high wear and for this reason, the chute must allow proper ergonomic access for maintenance and adjustment not only of the chute components but also of the transport system components, such as belt rollers and cleaners.

Last but not least, the chute must be designed to minimise dust and noise pollution.

### SUMMARY OF THE INVENTION

In one form, this invention provides a method of using the design capabilities afforded by transfer chutes like the chute described and claimed in SA Patent m 91/7215—Chute (Baller). These chutes use cascade formations to create an accurately definable chute liner, in use, of the bulk materials being transferred.

According to this form of the invention, a method of lining a materials transfer chute against wear caused by the conveyance of a flowable bulk particulate material in a flowing stream of material through the chute, the method comprising the steps of determining, for the chute, the flow characteristics desired of the flowing stream of material in use, locating, during the design and construction of the chute, a plurality of cascade formations within the chute such that the cascade formations co-operatively define a plurality of cavities that are adapted, in use, to accumulate no more of the material conveyed through the chute than is sufficient to form, in predetermined areas of the chute, a lining of accumulated material upon which conveyed material impinges in moving through the chute and progressively adjusting, during the design and construction of the chute, either or both the shape and size of successive cascade formations along the intended path of conveyance of the flowing stream of material through the chute in dependence on the desired flow characteristics of the flowing stream of material through the chute in use.

The step of locating the cascade formations within the chute may comprise the specific steps of locating a plurality of trays within the chute, the trays including free edges that project into the chute and face the intended incoming materials flow, a plurality of the trays each being provided with an upstanding wear lip that extends along the free edge of the tray, the trays and wear lips being adapted to define, co-operatively, dead boxes in which the bulk material may accumulate during material flow through the chute, the method including the steps of dimensioning the trays such that the free edges of the trays are co-extensive with imaginary lines of curvature connecting the free edges of the trays and such that the dead boxes accumulate no more of the material conveyed through the chute than is sufficient to form, in predetermined areas of the chute, a lining of accumulated material upon which conveyed material impinges in moving through the chute (to the extent that no more than parts of the wear lips are exposed to the bulk material flowing through the chute), the trays and the material accumulated therein being adapted, in use, to form a composite dead box, the surface of which is the wear surface that is co-extensive with the imaginary lines of curvature.

Since the wear surface follows the imaginary lines of curvature defined by the free edges of the trays, the designer can now use the tray dimensions accurately to design and dimension the wear surface.

The chute may be separated into one or more of a receiving section, a main chute body and a load-out section, each of which is adapted, singly or in combination, to form a wear surface in use and which wear surface is adapted to modify the vertical and horizontal components of motion of the stream of material in at least part of its passage into, through or out of one or more of the receiving section, the main chute body and the load-out section.

In respect of the latter configuration of the invention, the method may include the specific steps, during the design and construction of a chute adapted to deposit the flowing stream of material on a receiving belt, of adapting the load-out section to form a wear surface in use which wear surface is adapted to modify the vertical and horizontal components of motion of the flowing stream of material discharging from the load-out section at least partially to match one or more of the receiving belt travel direction and velocity.

The invention includes a materials transfer chute including a plurality of cascade formations within the chute, the cascade formations co-operatively defining a plurality of cavities that are adapted, in use, to accumulate no more of the material conveyed through the chute than is sufficient to form, in predetermined areas of the chute, a lining of accumulated material upon which conveyed material impinges in moving through the chute, the dimensions of the cascade formations varying progressively to vary either or both the shape and size of successive cascade formations along the intended path of conveyance of the flowing stream of material through the chute in dependence on the desired flow characteristics of the flowing stream of material through the chute in use.

The cascade formations may be constituted by a plurality of trays within the chute, the trays including free edges that project into the chute and face the intended incoming materials flow, a plurality of the trays each being provided with an upstanding wear lip that extends along the free edge of the tray, the trays and wear lips being adapted to define, co-operatively, dead boxes in which the bulk material may accumulate during material flow through the chute, the trays being dimensioned such that the free edges of the trays are co-extensive with imaginary lines of curvature connecting the free edges of the trays and such that the dead boxes accumulate no more of the material conveyed through the chute than is sufficient to form, in predetermined areas of the chute, a lining of accumulated material upon which conveyed material impinges in moving through the chute (to the extent that no more than parts of the wear lips are exposed to the bulk material flowing through the chute), the trays and the material accumulated therein being adapted, in use, to form a composite dead box, the surface of which is the wear surface that is co-extensive with the imaginary lines of curvature.

The chute may be notionally separated into one or more of a receiving section, a main chute body and a load-out section, each of which is adapted, singly or in combination, to form a wear surface in use which wear surface is adapted to modify the vertical and horizontal components of motion of the stream of material in at least part of its passage into, through or out of one or more of the receiving section, the main chute body and the load-out section.

This specific chute may be adapted to deposit the flowing stream of material on a receiving belt, the load-out section of the chute being adapted to form a wear surface in use which wear surface is adapted to modify the vertical and horizontal components of motion of the flowing stream of material discharging from the load-out section at least partially to match one or more of the receiving belt travel direction and velocity.

### BRIEF DESCRIPTION OF THE DRAWINGS

In the accompanying drawings:

FIG. 1 is a diagrammatic sectional side elevation of a transfer point for coarse bulk materials that illustrates the use of dead boxes or rock boxes;

FIG. 2 is a diagrammatic isometric view of the transfer chute described and claimed in SA Patent m 91/7215—Chute (Baller) which illustrates the use of an advanced chute liner forming arrangement that, in use, creates a chute liner of the bulk materials being transferred; and

FIG. 3 is a diagrammatic section through a similar chute by means of which the method of operation of the invention will be illustrated.

### DESCRIPTION OF EMBODIMENTS OF THE INVENTION

Bearing in mind that the primary purpose of a chute in a transfer point is to redirect the flow of a stream of materials, it has been recognised that a chute has three distinct sections, each requiring a different but integrated design approach.

The upper or receiving section of the chute assembly has the principal role of receiving the bulk materials from a source or in-feed, which could be the outlet of a bunker or hopper but which, in most situations is constituted by an in-feed belt running over a discharge pulley at the head end of the belt. The main chute body serves to stabilise the flow characteristics of the flowing stream of material and the lower or load-out section loads the receiving belt.

Dead boxes are areas within the chute that are designed to accumulate quantities of the material being conveyed or transferred. Where the transferred material is rock or ore, the dead boxes are often referred to as rock boxes. In the transfer of abrasive or coarse bulk materials, dead boxes or rock boxes have, in the past, been used to serve as a crude form of flow redirecting mechanism and to protect the internal surfaces of the chute in the areas in which the flow is so redirected.

It is now generally accepted that dead boxes introduce a degree of unpredictability which renders their use undesirable given the trend towards higher performance belt conveyor systems. These systems utilise substantially higher belt speeds and narrower belts in order to achieve greater economic efficiency. It will be appreciated that the greater accuracy in design that is required in such high-performance belt conveying systems mitigates against the use of components that do not have predeterminable performance characteristics.

Dead boxes tend to introduce unpredictable material flows within the chute since material compacted within the dead box tends to form rills or channels at angles to the material flow. In addition, the impact face of the compacted material within a dead box is invariably not constant and the shape thereof changes all the time. It will be appreciated that a bulk materials stream impacting on such a varying impact face in a dead box has resultant components of motion (velocity and direction of flow) that cannot be predicted or controlled with any real degree of certainty.

With these concerns in mind, it will be understood why more accurate control mechanisms, such as impact plates, are preferred as a means of redirecting bulk materials streams in transfer chutes forming part of high-performance conveyor belt systems. Impact plates, however, are far from ideal. They are designed and regarded as sacrificial items and, even with appropriate lining materials, tend to wear and need replacement quite regularly. This detracts from the flow control accuracy and predictability that impact plates might yield.

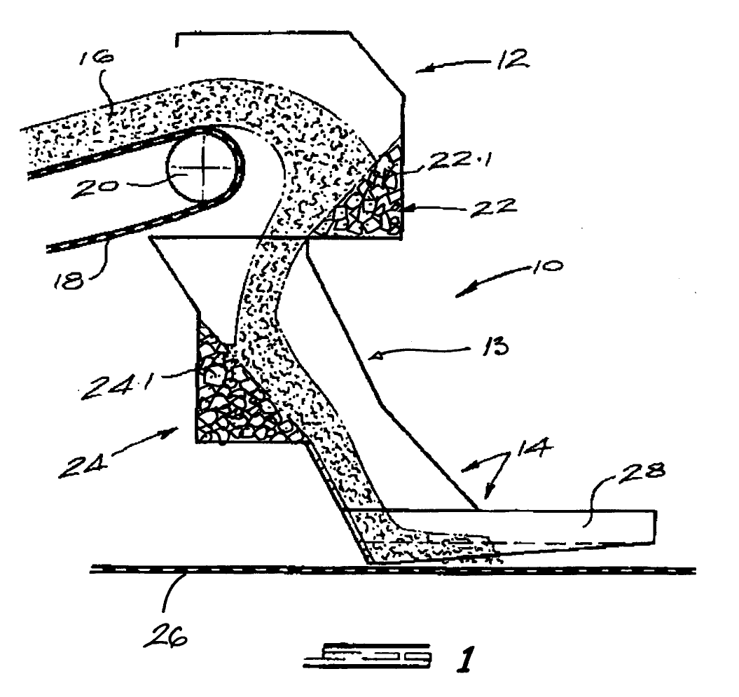

Referring to FIG. 1, it is possible to gain some understanding of these concerns.

The transfer chute 10 illustrated in FIG. 1 comprises a bulk materials receiving section 12, a main chute body 13 and a load-out section 14. A particulate bulk material 16 is fed from an in-feed conveyor belt 18 that projects the bulk materials 16 in a curved trajectory into the receiving section 12 over a head-end pulley 20. From the receiving section 12 the material 16 cascades into the main chute body 13 and from there to the load-out section 14, which directs the material 16 onto a receiving belt 26.

Rock boxes 22, 24 are formed in both the receiving section 12 and the main chute body 13 and compacted material 22.1, 24.1 accumulates in the rock boxes 22, 24. The rock boxes are positioned in the areas of impact and flow redirection of the bulk material stream within the chute 10.

In the receiving section 12, the material 16 is projected onto the surface of the compacted material 22.1 in the receiving section rock box 22 which redirects the flow of the bulk materials 16 onto the surface of the material 24.1 compacted in the main chute body rock box 24.

Observations of rock boxes (such as the rock boxes 22, 24) have shown that the material compacted within the rock box forms rills or channels at angles to the principal material flow direction. In addition, the impact face of the compacted material within a rock box (such as the inclined faces of the material 22.1, 24.1 compacted within the rock boxes 22, 24) is invariably not constant (planar in the example shown) even though it is assumed to be this shape by the designer. Instead, the impact face of the compacted material often forms a multiple-curved concave surface, the shape of which varies with time in dependence on the degree of scouring by the impinging bulk materials stream. The angle of inclination of the compacted material also tends to vary with variation of the cohesiveness of the bulk materials which, in turn, change with the inevitable variation in moisture content, size distribution and material make-up.

It will be appreciated that a bulk materials stream flowing across such variable impact an flow surfaces has resultant components of motion that cannot be predicted nor controlled with any degree of accuracy.

With these concerns in mind, it will be understood why more controllable mechanisms, such as impact plates, are preferred as a means of redirecting bulk materials streams in transfer points forming part of high-performance conveyor belt systems. This is more often the case in belt systems that are used to transport bulk materials with a variable properties and where the system utilises moderate to high belt speeds (that may vary in operation) and angled transfer points.

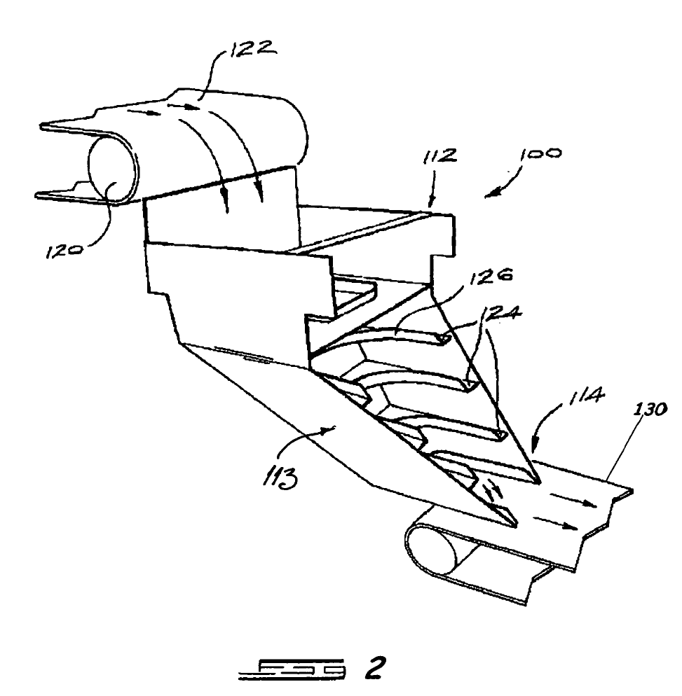

The chute 100 of FIG. 2 was originally designed to address certain of these problems. The chute 100 is shown in FIG. 2 in simplified form for purposes of illustration. In addition, the front face or cover plates of the chute 100 is not drawn in order better to illustrate the interior of the chute 100.

The chute 100 comprises a bulk materials receiving section 112 and a load-out section 114 with a main chute body 113 in-between. A particulate bulk materials is fed from an in-feed conveyor belt 122 through the chute 100. The bulk materials is projected into the receiving section 112 in a curved trajectory over the head-end pulley 120 of the in-feed conveyor belt system.

The interior of the main chute body is provided with a number of trays 124 that define steps or ledges with free edges that project into the chute 100 facing the incoming materials flow. The majority of the trays 124 are provided with an upstanding wear 126 lip that extends along the free edge of the tray 124.

In effect, each of the trays 124 defines a step or ledge that serves as a mini dead box or rock box into which the bulk materials is projected on commencement of material flow through the chute 100. The material accumulates rapidly within the rock boxes as material flow continues and the material is eventually compacted within the rock boxes to the extent that only the wear lips 126 (and then often only parts of the wear lips 126) are exposed to the bulk material flowing through the chute 100.

The free edges of the trays 124 are co-extensive with complex curves extending along imaginary lines connecting the free edges of the trays, so that the trays and the material accumulated therein are adapted, in use, form a composite dead box with a surface that is exposed to the incoming material and that is curved along a curvature that intersects, at least partly, the path of the incoming and flowing material.

It is this interaction of the flowing material with the complex curved surface of chutes such as the chutes 100, 200 that forms the essence of this invention.

Due to the diminutive size of the rock boxes (which is determined by the proximity of the trays 124 to one another), the compacted bulk materials forms a curved wear or impact surface. However, the shape and configuration of the impact surface is not determined by the accumulated bulk materials. Instead, the material that accumulates in each rock box tends to blend into the material accumulated in each of the rock boxes adjacent thereto. However, the rock boxes do not overfill. The flow of material through the chute 100 tends to remove any pieces of material that are not securely compacted within a rock box. In this manner, the combination of trays 124 and accumulated material (that is constrained by the wear lips 126) form a curved liner of accumulated material within the chute 100. The shape and configuration of the impact surface of the resultant curved liner conforms relatively precisely to the outline and profile of the rock boxes, as determined by the shape of the trays 124.

This tends to mitigate the unpredictability associated with conventional rock boxes and instead, the shape of the trays 124 and wear lips 126 can now be used to define, reasonably predictably, the geometry of the curved liner of compacted bulk material that forms within the chute 100.

Due to the proximity of the trays 124 to one another the compacted bulk materials forms a wear surface in which rilling and channel formation is avoided or it is so negligible that it has little or no effect on the flow of the material stream through the chute 100.

It will be appreciated that the lining material being the same as the transferred bulk materials, it provides an ideal wear surface 12.2 within the chute 100 that serves to minimise wear on the chute components. In essence, the chute 100 constitutes a material-on-material transfer chute in which the bulk material stream flows across a similar material wear liner.

The method of operation of this invention constitutes a method of using the design capabilities afforded by the relatively well definable and predictable geometry of the curved liner of compacted bulk materials that forms within the chute 100 to control the flow of the bulk materials into, through and out of the chute 100.

To do this, the chute is notionally separated into its three main constituents—receiving section, main chute body and load-out section—which are then consciously designed, adapted and used, singly or in combination, to modify the vertical and horizontal components of motion of the stream of material all the way into, through and out of the chute in a manner that maximises the conveyor belt system utilisation and that minimises environmental impact.

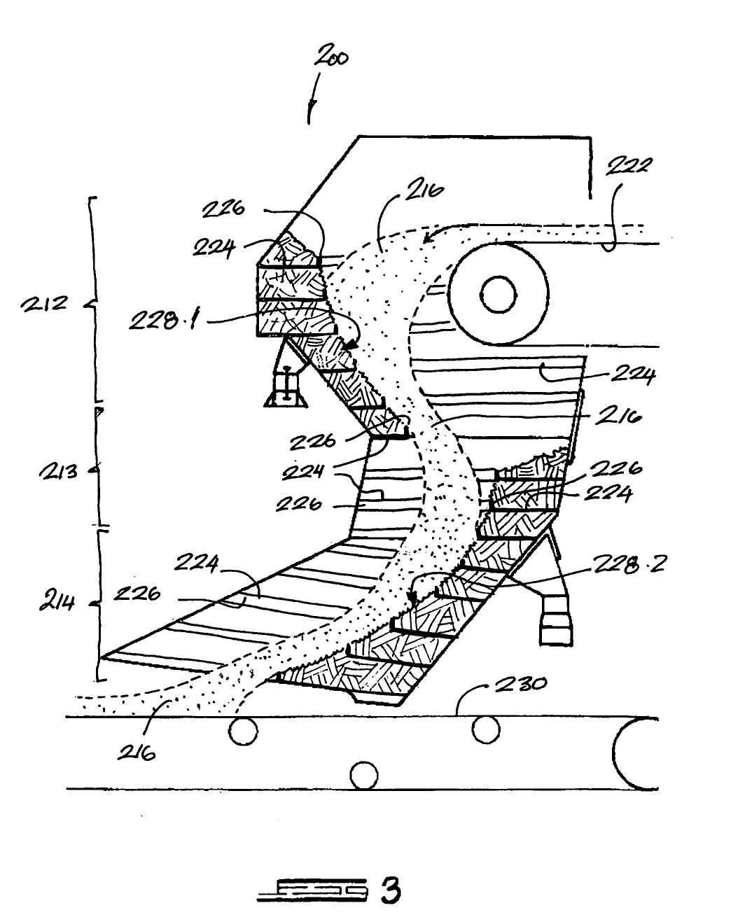

This is best illustrated with reference to FIG. 3

This drawing illustrates a chute 200 with a receiving section 212, a main chute body 213 and a load-out section 214 within which trays 224 with wear lips 226 are placed to define a wear surface 228. The free edges of the trays 224 wear lips 226 are co-extensive with complex curves extending along imaginary lines connecting the free edges of the trays and lips, so that the trays and the material accumulated therein, in use, form a composite dead box with a surface that is exposed to the flowing stream of material 216 and that is curved along a curvature that intersects, at least partly, the path of the flowing stream of material 216.

Since the wear surface 228 follows the imaginary lines of curvature defined by the free edges of the trays 224 and wear lips 226, the designer can now use the tray dimensions accurately to design and dimension the wear surface 228.

In the receiving section 212, the curvature of the wear surface 228.1 is designed to receive the impact of the flowing stream of material 216 and to constrain the stream of material projected off the end of the in-feed belt 222 into a modified, truncated trajectory (compared to the natural un-constrained trajectory of the stream of material). This is intended to modify the components of motion of the stream of material, by reducing the belt-induced velocity of the flowing stream of material 216 (the velocity in the direction of travel of the belt 222) and converting and reversing the direction of travel of the flowing stream of material 216 into downward and rearward travel within the receiving section 212.

In the main chute body 213 the flow characteristics of the flowing stream of material 216 are stabilised and the flowing stream of material 216 is centralised within the main chute body 213. This is done by increasing the downward velocity of the flowing stream of material 216 by gravitational acceleration. In addition, the direction of motion of the flowing stream of material 216 is reversed once again. The reversal of direction of the flowing stream of material 216 has the advantage of altering the distribution of fines in the flowing stream of material 216 thereby to ensure that coarse material is deposited on finer material on the load-out section 214.

In the load-out section 214 the components of motion of the material stream are modified finally. The flowing stream of material 216 is decelerated with the aid of a gradually inclined wear surface 228.2 and centralised further for symmetrical loading of the receiving belt 230.

The wear surface in the load-out section 214 is designed to deposit the flowing stream of material 216 symmetrically on the receiving belt 230 in a manner which minimises wear on the belting and conveyor structures. The load-out section 214 wear surface 228.2 is designed to accelerate (or decelerate) the flowing stream of material 216 to the extent that the velocity and direction of travel of the flowing stream of material 216 discharging from the load-out section 214 are matched with the belt travel direction and velocity to the greatest possible extent. This minimises abrasive wear of the belt and the belt power required to accelerate the materials to the belt velocity.

In addition, the components of motion of the flowing stream of material 216 normal to the belt plane at the point of discharge of the flowing stream of material 216 are kept as low as possible in order to minimise impact damage of the belt and the belt support structure in the impact area.

By addressing this requirement adequately, it is also possible to minimise spillage due to particle rebounding and to reduce dust and noise levels significantly.

The above mentioned examples of the design possibilities offered by the use of the trays 224 and wear lips 226 are purely illustrative. Using the principles outlined above and understanding the design considerations involved and, in respect of each chute, the nature of the design problem to be overcome, it is possible to design a multiplicity of chutes, each purpose designed to maximise conveying system utilisation and to minimise environmental impact.

In this regard, the most important design considerations relate to the treatment of the flowing stream of material 216 as a controllable entity, from the point at which the flowing stream of material 216 leaves the in-feed belt 222, through the chute 200 to the off take area of the flowing stream of material 216 on the receiving belt 230. Equally importantly, in controlling the flowing stream of material 216, the method of the invention envisages the use of gradual and non-aggressive intervention with the flowing stream of material 216 to modify the components of motion thereof, which requires careful consideration to the areas of intersection between the wear surfaces 228 and the flowing stream of material 216.

Referring to FIG. 2 it will be seen that the chutes used in conjunction with the method of the invention create a wear surface 228 that is curved in three dimensions and particularly in the vertical and horizontal axes. Not only do successive trays 224 define a vertically curved wear surface 228 as illustrated in FIG. 3, but the individual trays 224 also curve around horizontally within the chute 200. In plan view, the free edges of the trays 224 that project towards the flowing stream of material 216, follow parabolic curves.

In the receiving section 212, the vertices of the curves are remote from and face into the flowing stream of material 216 discharging off the in-feed belt 222. The trays 224 in the receiving section 212 face the head end pulley 220 and then curve outwardly to open towards the sides of the receiving section 212. In the main chute body 213, the trays 224 are reversed. The vertices of the curves defined by the trays 224 in the main chute body 213 face in the same direction as the belt discharge (the head end pulley 220) and then curve outwardly, opening towards the sides of the main chute body 213, so that they face into the and receive the flowing stream of material 216 discharging from the receiving section 212. In the example illustrated in FIG. 3, the load-out section 214 simply continues the curvature of the main chute body 213 with the exception that the wear surface 228.3 in the load-out section 214 is decurved to assist with the gravitational deceleration of the flowing stream of material 216 load-out section 214.

The From the drawing it will be seen that the chute 200 itself is not curved and that the curvature of the wear surface is determined by the shape of the trays 224.

The trays 224 can be shaped to provide horizontal and vertical curvatures as required by the particular application.

Due to the proximity of the trays 224 to one another, however, the shape and configuration of the inclined surface of the compacted bulk materials is determined not only by the accumulated material, as is the case with conventional rock boxes. Instead, the bulk materials accumulating in the area of each of the trays 224 tends to blend into the material accumulated in the area of each of the trays 224 adjacent thereto. In this manner, the combination of trays 224 and accumulated material (that is constrained by the trays 224) form a liner of accumulated material within the chute 200, the shape and configuration of which conforms predictably to the outline and profile selected by the designer.

This tends to mitigate the unpredictability associated with conventional rock boxes and instead, the shape of the trays 224 and lips 226 are now used to define, predictably, the geometry of the entire lining of compacted bulk materials that forms within the chute 200. Rilling and channel formation is avoided in the chute 200 or it is so negligible that it has little or no effect on the travel of the bulk materials through the chute 200.

In addition, the “wear surface” of the compacted bulk materials constituting the chute lining can be designed to conform to a predictable shape within the chute 200 notwithstanding variations within the bulk materials.

It will be appreciated that the entire chute 200 will be designed with the abovementioned design criteria in mind to ensure that the chute is properly integrated within the transport system of which it forms a part.

1. A method of lining a materials transfer chute against wear caused by the conveyance of a flowable bulk particulate material in a flowing stream of material through the chute, the method comprising the steps of determining, for the chute, the flow characteristics desired of the flowing stream of material in use, locating, during the design and construction of the chute, a plurality of cascade formations within the chute such that the cascade formations co-operatively define a plurality of cavities that are adapted, in use, to accumulate no more of the material conveyed through the chute than is sufficient to form, in predetermined areas of the chute, a lining of accumulated material upon which conveyed material impinges in moving through the chute and progressively adjusting, during the design and construction of the chute, either or both the shape and size of successive cascade formations along the intended path of conveyance of the flowing stream of material through the chute in dependence on the desired flow characteristics of the flowing stream of material through the chute in use.

2. A method according to claim 1 in which, during the design and construction of the chute, the cascade formations are adapted to form a wear surface in use which wear surface is adapted to modify the vertical and horizontal components of motion of the stream of material in at least part of its passage into, through or out of the chute in dependence on the desired flow characteristics of the flowing stream of material through the chute in use, the method of the invention including the specific steps of locating the cascade formations within the chute such that the cascade formations co-operatively form a wear surface in use, the cascade formations being located to define a plurality of cavities that are adapted, in use, to accumulate no more of the material conveyed through the chute than is sufficient to form, in predetermined areas of the chute, a lining of accumulated material upon which conveyed material impinges in moving through the chute and progressively adjusting, during the design and construction of the chute, either or both the shape and size of successive cascade formations along the intended path of conveyance of the flowing stream of material through the chute to permit the formation of the wear surface in use.

3. A method according to claim 2 in which the step of locating the cascade formations within the chute comprises the specific steps of locating a plurality of trays within the chute, the trays including free edges that project into the chute and face the intended incoming materials flow, a plurality of the trays each being provided with an upstanding wear lip that extends along the free edge of the tray, the trays and wear lips being adapted to define, co-operatively, dead boxes in which the bulk material may accumulate during material flow through the chute, the method including the steps of dimensioning the trays such that the free edges of the trays are co-extensive with imaginary lines of curvature connecting the free edges of the trays and such that the dead boxes accumulate no more of the material conveyed through the chute than is sufficient to form, in predetermined areas of the chute, a lining of accumulated material upon which conveyed material impinges in moving through the chute (to the extent that no more than parts of the wear lips are exposed to the bulk material flowing through the chute), the trays and the material accumulated therein being adapted, in use, to form a composite dead box, the surface of which is the wear surface that is co-extensive with the imaginary lines of curvature.

4. A method according to any one of the preceding claims in which, during the design and construction of the chute, the chute is separated into one or more of a receiving section, a main chute body and a load-out section, each of which is adapted, singly or in combination, to form a wear surface in use which wear surface is adapted to modify the vertical and horizontal components of motion of the stream of material in at least part of its passage into, through or out of the receiving section, the main chute body and the load-out section.

5. A method according to claim 4 which includes the specific steps, during the design and construction of a chute adapted to deposit the flowing stream of material on a receiving belt, of adapting the load-out section to form a wear surface in use which wear surface is adapted to modify the vertical and horizontal components of motion of the flowing stream of material discharging from the load-out section at least partially to match one or more of the receiving belt travel direction and velocity.

6. A materials transfer chute including a plurality of cascade formations within the chute, the cascade formations co-operatively defining a plurality of cavities that are adapted, in use, to accumulate no more of the material conveyed through the chute than is sufficient to form, in predetermined areas of the chute, a lining of accumulated material upon which conveyed material impinges in moving through the chute, the dimensions of the cascade formations varying progressively to vary either or both the shape and size of successive cascade formations along the intended path of conveyance of the flowing stream of material through the chute in dependence on the desired flow characteristics of the flowing stream of material through the chute in use.

7. A chute according to claim 6 in which the cascade formations are adapted to form a wear surface in use which wear surface is adapted to modify the vertical and horizontal components of motion of the stream of material in at least part of its passage into, through or out of the chute, the cascade formations being located within the chute such that the cascade formations co-operatively define a plurality of cavities that are adapted, in use, to accumulate no more of the material conveyed through the chute than is sufficient to form, in predetermined areas of the chute, a lining of accumulated material upon which conveyed material impinges in moving through the chute, the dimensions of the cascade formations varying progressively to vary either or both the shape and size of successive cascade formations along the intended path of conveyance of the flowing stream of material through the chute in dependence on the desired flow characteristics of the flowing stream of material through the chute in use.

8. A chute according to claim 7 in which the cascade formations are constituted by a plurality of trays within the chute, the trays including free edges that project into the chute and face the intended incoming materials flow, a plurality of the trays each being provided with an upstanding wear lip that extends along the free edge of the tray, the trays and wear lips being adapted to define, co-operatively, dead boxes in which the bulk material may accumulate during material flow through the chute, the trays being dimensioned such that the free edges of the trays are co-extensive with imaginary lines of curvature connecting the free edges of the trays and such that the dead boxes accumulate no more of the material conveyed through the chute than is sufficient to form, in predetermined areas of the chute, a lining of accumulated material upon which conveyed material impinges in moving through the chute (to the extent that no more than parts of the wear lips are exposed to the bulk material flowing through the chute), the trays and the material accumulated therein being adapted, in use, to form a composite dead box, the surface of which is the wear surface that is co-extensive with the imaginary lines of curvature.

9. A chute according to any one of claims 6 to 8 which is separated into one or more of a receiving section, a main chute body and a load-out section, each of which is adapted, singly or in combination, to form a wear surface in use which wear surface is adapted to modify the vertical and horizontal components of motion of the stream of material in at least part of its passage into, through or out of the receiving section, the main chute body and the load-out section.

10. A chute according to claim 9 which is adapted to deposit the flowing stream of material on a receiving belt, the load-out section of the chute being adapted to form a wear surface in use which wear surface is adapted to modify the vertical and horizontal components of motion of the flowing stream of material discharging from the load-out section at least partially to match one or more of the receiving belt travel direction and velocity.
